(19) United States
(12) Patent Application Publication
(10) Pub. No.: US 2024/0427601 A1
(43) Pub. Date: Dec. 26, 2024

(54) METHODS AND APPARATUS TO FACILITATE UNALIGNED BYTE STREAM OPERATIONS

(71) Applicant: Texas Instruments Incorporated, Dallas, TX (US)

(72) Inventors: Venkatesh Natarajan, Bangalore (IN); Alexander Tessarolo, Lindfield (AU)

(21) Appl. No.: 18/441,796

(22) Filed: Feb. 14, 2024

(30) Foreign Application Priority Data
Jun. 23, 2023 (IN) 202341042579

(51) Int. Cl. G06F 9/30; G06F 9/38

(52) U.S. Cl. CPC G06F 9/30196; G06F 9/30029; G06F 9/3836

(57) ABSTRACT

Methods, apparatus, systems, and articles of manufacture are described to facilitate unaligned byte stream operations. An example apparatus includes a register including a first portion and a second portion; and a decoder to, responsive to obtaining an instruction, move at least some data from the first portion of the register to the second portion of the register based on an address identified in the instruction; an interface to cause a multiple-byte read to access data from an aligned address of memory; and the decoder to store the accessed data into the first portion of the register based on the address identified in the instruction.

### RELATED APPLICATIONS

This application claims priority to Indian Provisional Patent Application No. 202341042579, filed Jun. 23, 2023, which is incorporated herein by reference in its entirety.

### TECHNICAL FIELD

This description relates generally to circuits, and, more particularly, to methods and apparatus to facilitate unaligned byte stream operations.

### BACKGROUND

Processing circuitry executes tasks by performing operations on data in registers. Because the amount of space in the registers of the processing circuitry is limited, processing circuitry interfaces with external memory that has a large amount of space to store data. Processing units include data read and/or data write interfaces that can read and/or write data to/from the memory. Some interfaces are capable of accessing and/or writing multiple bytes of data at a time.

### SUMMARY

An example of the description includes an apparatus which includes a register including a first portion and a second portion; and a decoder to, responsive to obtaining an instruction, move at least some data from the first portion of the register to the second portion of the register based on an address identified in the instruction; an interface to cause a multiple-byte read to access data from an aligned address of memory; and the decoder to store the accessed data into the first portion of the register based on the address identified in the instruction.

### BRIEF DESCRIPTION OF THE DRAWINGS

FIG. 1 is example processing circuitry to facilitate unaligned byte stream operations.

FIG. 2 is a block diagram of an example of byte stream optimization circuitry of FIG. 1.

FIGS. 3A-3B illustrate a flowchart representative of example machine readable instructions and/or example operations that may be executed, instantiated, and/or performed by example programmable circuitry to implement the byte stream optimization circuitry of FIG. 1 to execute a chained-load operation.

FIGS. 4A-4B illustrate a flowchart representative of example machine readable instructions and/or example operations that may be executed, instantiated, and/or performed by example programmable circuitry to implement the byte stream optimization circuitry of FIG. 1 to execute a chained-move operation.

FIG. 5 illustrates example structure of memory.

FIG. 6 illustrates results of the execution of two chained-load instructions.

FIG. 7 illustrates an example of the results of multiple chained-load operations.

FIG. 8 illustrates results of the execution of a chained-move instruction.

FIG. 9 is a block diagram of an example processing platform including programmable circuitry structured to execute, instantiate, and/or perform the example machine readable instructions and/or perform the example operations of FIGS. 3A-4B to implement the byte stream optimization circuitry of FIG. 2.

The same reference numbers or other reference designators are used in the drawings to designate the same or similar (functionally and/or structurally) features.

### DETAILED DESCRIPTION

The drawings are not necessarily to scale. Generally, the same reference numbers in the drawing(s) and this description refer to the same or like parts. Although the drawings show regions with clean lines and boundaries, some or all of these lines and/or boundaries may be idealized. In reality, the boundaries and/or lines may be unobservable, blended and/or irregular.

Processing units (central processing units (CPUs), graphical processing units (GPUs), etc.) execute instructions to perform one or more operations to manipulate data to perform a task. For example, processing units can perform operations on arrays of bytes (e.g., searching, matching, copying arrays from one location to another, etc.). Although many instructions cause the processing units to perform operations on data stored in registers and to store the results in these registers, register space may be quite limited. In between operations, the data is typically stored in external memory that has space and/or capacity to store far more information. Accordingly, processing units can access information from the memory, store the information in the registers, perform manipulation to the information in the register(s), and/or store the information and/or manipulated information back into the memory (e.g., at the same and/or different location of the memory).

However, the minimum data size for an instruction and/or operation (e.g., data granularity) may not be the same as the minimum data size for a given interface. For example, a given instruction may have a data size of one byte and an interface that provides the data may have a data size of multiple bytes (e.g., a word). The interface may also have a restriction on which bytes are included in a given word. Thus, the interfaces of a processing unit may be limited to performing aligned accesses. In an example, an aligned memory access means that the interface can read N bytes of data starting at an address that is evenly divisible by N. For example, if data stored in memory is 16 bytes long and the example interface is structured to perform 4 byte reads, the interface can only read the first four bytes (0-3), the second four bytes (4-7), the third four bytes (8-11), or the fourth four bytes (12-15) in a single access. Thus, if the processing unit wants to read the information located in byes 2-4 but the interface is limited to a 4-byte read operation, the interface performs a first read operation of bytes 0-3 (e.g., even though the processing unit will not use bytes 0 and 1 that were accessed during the aligned read operation) and a second read operation of bytes 4-7. Unaligned data is data that starts from a memory address that is not evenly divisible by the N number of bytes of data that is trying to be accessed. Accordingly, accessing unaligned data may include multiple aligned accesses and may gather some data that is needed and some data that is not needed.

In the example processing units described above, many instructions and operations are performed at a byte-level granularity. However, the interfaces of the processing units can access and/or write information to/from memory at larger sizes (e.g., four bytes or one word at a time). This means that for operations involving arrays of data in memory where the same operation is repeated for each byte, the processing circuitry can access a word of information at a time, but the processing circuitry executes an instruction on any combination of the bytes therein. Some operations can be adjusted to operate on more than one byte concurrently to match the size of the data being retrieved to decrease the number of cycles needed to execute the operation(s) on the complete array. For example, if an interface of a processing unit can access one word of data from memory at a time, the processing circuitry can also operate one word at a time, thereby conserving three cycles. However, in many examples, to perform operations one word at a time, the input and/or output data is stored aligned within the registers of the processing unit. This alignment in the register may be different than the alignment in the memory on the other side of the interface. In some examples, when the accessed information is aligned in memory, storing the data accessed from memory into a register may result in the data being aligned in the memory. However, especially when the accessed information is unaligned in the memory, an efficient operation is needed to ensure that the unaligned data is accessed from memory and stored in a register in the correct order (e.g., so that the data of interest is aligned with respect to the register).

Examples described herein provide specialized instructions (e.g., a chained-load, LDCHAIN, or LDCHAINB.32 (for a 32-bit instruction) instruction) for accessing unaligned data from memory and storing into a register in the correct order for a subsequent processor operation. The specialized instruction, when executed by the processing unit performs a load data chain operation that ensures that aligned and/or unaligned data is stored in the processing units register(s) in the correct alignment. Also, examples described herein provide specialized instructions (e.g., chained-move, or MVCHAIN, MVCHAINB.32 (for a 32-bit chained-move) instruction) for moving aligned and/or unaligned data from one register to another register. Using examples described herein, regardless of the alignment of the bytes in the memory, at the end of the specialized instructions, the processing unit has aligned data stored in the register(s). In this manner, the processing unit can perform subsequent data movement operations and/or data processing operations to multiple bytes (e.g., 4 bytes) at a time, instead of 1 byte at a time, regardless of whether the starting byte was at a word aligned address with respect to the memory or not.

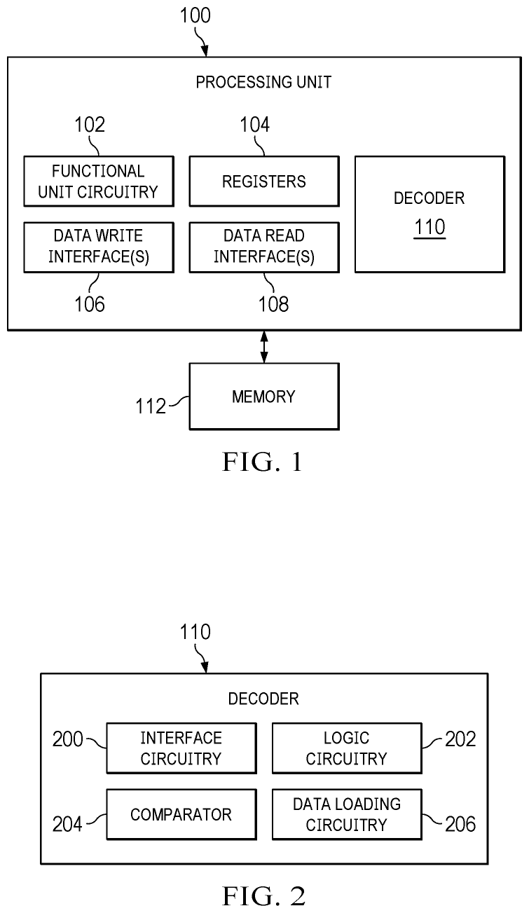

FIG. 1 illustrates an example processing unit 100. The processing unit 100 may be a CPU, GPU, and/or any other type of processing unit and/or architecture. The example processing unit 100 includes example functional unit circuitry 102, example registers 104, example data write interface(s) 106, example data read interface(s) 108, and example decoder 110. FIG. 1 further includes example memory 112.

The functional unit circuitry 102 of FIG. 1 executes instructions to access, modify, move, and/or store data to and/or from the memory 112. To modify and/or move data from the memory 112, the functional unit circuitry 102 can cause the data read interface(s) 106 to read and/or access data from a particular address(es) in the memory 112. The data read interface(s) 108 store(s) the read and/or accessed information from the memory 112 into one or more registers 104. The functional unit circuitry 102 can then modify the data in the register 104 by performing one or more operations. To store and/or move data to the memory 112 the functional unit circuitry 102 can cause the data read interface(s) 108 to write data to a particular address(es) in the memory 112.

The registers 104 of FIG. 1 temporarily store data that the functional unit circuitry 102 may utilize to perform one or more operations. Each register of the registers 104 may be sized to fit any size data (e.g., 1 byte, 2 bytes, 4 bytes, 8 bytes, etc.). The registers 104 may store an instruction, a storage address, and/or any kind of data (e.g., such as a sequence and/or array of data from and/or to be stored in the memory 112). The registers 104 include hardware (e.g., flip flops) that can be manipulated to store particular data. The registers 104 can include one or more program counters, instruction registers, accumulators, general-purpose registers, address registers, stack pointers, data registers, status registers, flag registers, control registers, etc.

The data write interface(s) 106 of FIG. 1 interface with (e.g., write data to) the memory 112. The data write interface(s) 106 writes information to (e.g., stores in) a particular address(es) of the memory 112. In some examples, the data write interface(s) 106 accesses data from the register(s) 104 and writes the accessed data to the memory 112. In some examples, the data write interface(s) 106 uses data (e.g., pointer information) from the register(s) 104 to determine what address in the memory 112 to write the data to. The data write interface(s) 106 is/are capable of performing a write operation to store one or more bytes (e.g., 1 byte, 2 bytes, 4 bytes, 8 bytes, etc.) of information at the same time.

The data read interface(s) 108 of FIG. 1 interface with (e.g., read data from) the memory 112. The data read interface(s) 108 reads and/or accesses information from a particular address(es) of the memory 112. In some examples, the data read interface(s) 108 stores accessed data from the memory 112 to the register(s) 104. The data read interface(s) 108 is/are capable of performing a read operation to retrieve one or more bytes (e.g., 1 byte, 2 bytes, 4 bytes, 8 bytes, etc.) of information at the same time.

The decoder 110 of FIG. 1 performs an operation when a multiple-byte load instruction is to be executed. The decoder 110 ensures, when a specialized instruction (e.g., LDCHAIN, LDCHAIN.32 for a 32 bit load, etc.) is called, that the multiple-byte data that is accessed from the memory 112 is stored in the correct order in the registers 104 regardless of whether the data being loaded is aligned or unaligned with respect to memory 112. For example, the specialized instruction may be a chained-load instruction that, when executed, loads a register (e.g., an 8-byte register) of the registers 104 with a multiple-byte word (e.g., 4-byte word) from a memory address location (e.g., ADDR1) of the memory 112. The decoder 110 loads the multiple-byte word from the memory 112 into the register based on the least significant bits (e.g., least significant 2 bits for 32-bit data) of the memory address identified in the LDCHAIN instruction. The least significant bits correspond to how misaligned the data that is to be loaded is within the memory 112. Unlike some load multi-byte load instructions, where the least significant X bits (e.g., where X is 2 for a 32 bit load) are expected to be 00 (e.g., to ensure that the load operation is aligned with the structure of the memory 112), there is no such restrictions for the disclose LDCHAIN function. Instead, the decoder 110 can use the information from the least significant bits to determine the alignment of the data in the memory 112 and adjust operation based on the determined alignment. Also, the decoder 110 zeros out the X least significant bits so that the data read interface 108 can perform the aligned access. The decoder 110 then stores the accessed data into the register based on the X least significant bits.

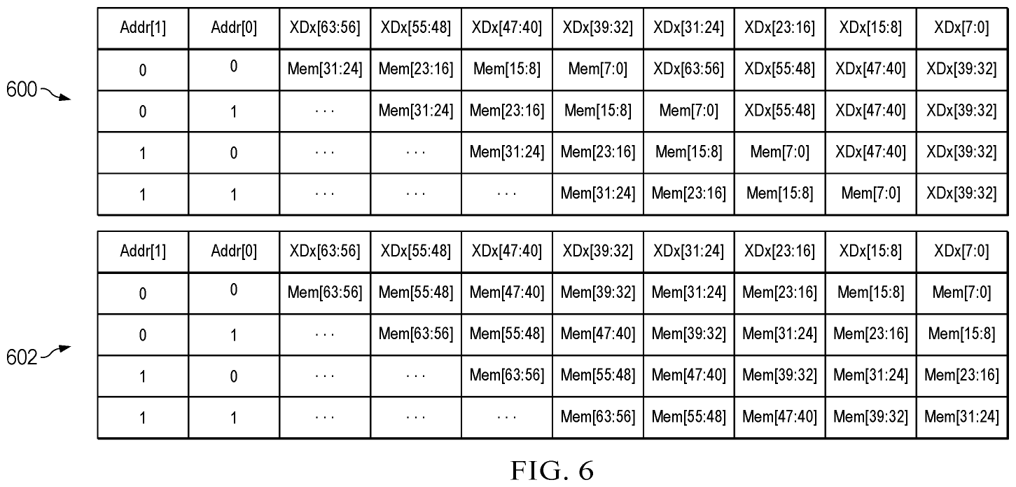

The LDCHAIN instruction includes two operands ADDR1 and XDx. ADDR1 corresponds to a pointer value for a starting address of the memory 112 where the data to be loaded is stored (e.g., an indirect encoding of an address). In some examples, the ADDR1 can be set to a variable pointer value. For example, the ADDR1 can be set to a pointer value that is incremented to a subsequent aligned word address each time the LDCHAIN instruction is called. In this manner, the LDCHAIN instruction can be called twice in a row to access subsequent data from memory. XDx represents an available register pair corresponding to where the loaded data is loaded to in the registers 104. The register pair are two 32-bit registers structured to operate as a single 64-bit register. To ensure that the unaligned data in the memory 112 is aligned in the destination register, the decoder 110 performs the LDCHAIN operation at least twice by executing the LDCHAIN instruction at least twice. For each LDCHAIN operation performed after the initial LDCHAIN operation, the pointer for the multi-byte read operation is incremented to a subsequent aligned word address, thereby causing the unaligned data in memory to be stored in the register in an aligned manner. An example of two LDCHAIN operations resulting in aligned data in a register is further described below in conjunction with FIG. 6. Example Pseudocode corresponding to the LDCHAIN instruction and operation for a 32-bit load is shown in the below Table 1. The below pseudocode in Table 1 corresponds to a single 32-bit operation. To align data from memory that is larger than 32-bits, the LDCHAIN instruction is executed more than once. In the below table the previous values of the register XDx [0-63] may not be relevant for storing the unaligned data from memory in an aligned manner in a register.

TABLE 1
Pseudocode for LDCHAIN.32 XDx, ADDR1

```
mem32-data refers to the data of the memory location addressed by zeroing out the LSB 2
bits of generated address.
32-bit-aligned-addr = [ADDR1 & 0xfffffffc]; // Zero out the LSB 2 bits of the ADDR1
generated address to create a 32-bit address.
mem32-data = mem[32-bit-aligned-addr]; // This is the 32-bit data from the memory.
// The 32-bit data from the memory will be placed in the 64-bit XDx register depending on
the 2 least significant bits of the ADDR1 generated address
if (ADDR1[1:0] == 00){
  XDx[31:0] = XDx[63:32];
    XDx[63:32] = mem32-data;
}
if(ADDR1[1:0] == 01){
    XDx[23:0] = XDx[55:32];
    XDx[55:24] = mem32-data;
    XDx[63:56] = --; // 0 or unchanged.
}
if(ADDR1[1:0] == 10){
    XDx[15:0] = XDx[47:32];
    XDx[47:16] = mem32-data;
    XDx[63:48] = --; // 0 or unchanged.
}
if(ADDR1[1:0] == 11){
    XDx[7:0] = XDx[39:32];
    XDx[39:8] = mem32-data;
    XDx[63:40] = --; // 0 or unchanged.
}
```

In the above pseudocode, the initial data in the registers (e.g., XDx [0:63] can be any data. The actual data is not relevant as the data is overwritten during the second LDCHAIN operation. Also, the decoder 110 of FIG. 1 performs an operation when a multiple-byte move operation is to occur (e.g., when a multiple-byte move instruction is executed). The decoder 110 ensures, when a specialized instruction (e.g., MVCHAIN, MVCHAIN.32 for a 32 bit move, etc.) is called, that the multiple-byte data that is moved from a first register of the registers 104 to a second register of the registers 104 regardless of whether the data being loaded is aligned or unaligned. For example, the specialized instruction may be a chained-move instruction, that, when executed, move data from a first register (e.g., a 4 byte register referred to as Dx) of the registers 104 to a second register (e.g., an 8 byte register referred to as XDy) of the register 104. The decoder 110 loads the 32-bit data from the Dx register into the 64-bit Xdy register based on bit values stored in particular locations (e.g., TDM2 and TDM3) of an (Execute Phase Status Register) ESTS register of the registers 104. The value in the TDM2 and TDM3 locations of the ESTS register include test flags that correspond to multiple conditions by testing the Dx register and Mx register operation flags. For example, the TDM2 and TDM3 can store values corresponding to how the data from the first register is aligned (e.g., whether the data is aligned, unaligned, and/or by how much the data is unaligned). The operands of the MVCHAIN instruction are TDM2, TDM3, XD2 (e.g., the destination register that will be partly read and where data from the source register will be written to), and DO (e.g., the source register with data that will be moved from). Thus, when the decoder 110 executes a MVCHAIN instruction, the decoder 110 causes a read of two values (e.g., corresponding to TDM2 and TDM3) from the ESTS register, a read of the data to be moved from a register (XD2). The MVCHAIN instruction and operation is further described below. Example Pseudocode corresponding to the MVCHAIN instruction and operation for a 32-bit move is shown in the below Table 1.

TABLE 2
Pseudocode for MVCHAIN.32 TDM3, TDM2, XD2, D0

```
// The 32-bit data from the source register be placed in the 64-bit XDx
register depending on the values of TDM3 and TDM2
if(TDM3, TDM2 == 0,0) {
  Xdy[31:0] = Dx[31:0];
  Xdy[63:32] = --; // value unchanged.
}
if(TDM3, TDM2 == 0,1) {
  Xdy[7:0] = Xdy[39:32];
  Xdy[39:8] = Dx[31:0];
  Xdy[63:40] = --; // value unchanged.
}
if(TDM3, TDM2 == 1,0) {
  Xdy[15:0] = Xdy[47:32];
  Xdy[47:16] = Dx[31:0];
  Xdy[63:48] = --; // value unchanged.
}
if(TDM3, TDM2 == 1,1) {
  Xdy[23:0] = Xdy[55:32];
  Xdy[55:24] = Dx[31:0];
  Xdy[63:56] = --; // value unchanged.
}
```

In the above pseudocode, the initial data in the registers (e.g., Xdy [0:63] can be any data as it is not relevant when moving the data chain. In some examples, the decoder 110, or portion thereof, is implemented by the functional unit circuitry 102. The functional unit circuitry 102 is further described below in conjunction with FIG. 2.

The memory 112 of FIG. 1 stores data. The processing unit 100 can access (e.g., read) and/or write data to/from the memory 112. As described above, the memory 112 provides larger storage than what is available in the processing unit 100. Accordingly, the processing unit 100 can use the memory 112 to store data that it may access later. The memory 112 may be volatile memory, non-volatile memory, solid state memory, flash memory, and/or any other type of memory.

FIG. 2 includes a block diagram of the decoder 110 of FIG. 1. The decoder 110 includes example interface circuitry 200, example logic circuitry 202, example comparator circuitry 204, and example data loading circuitry 206.

The example interface circuitry 200 of FIG. 2 communicates with the other components of the processing unit 100 (e.g., the functional unit circuitry 102, the registers 104, the data write interface(s) and/or the data read interface(s), and/or any other component of the processing unit 100). For example, the interface circuitry 108 may obtain instructions to perform a LDCHAIN and/or MVCHAIN operation from the functional unit circuitry 102. For example, if a LDCHAIN and/or MVCHAIN instruction is called, the functional unit circuitry 102 may instruct the decoder 110 to perform the LDCHAIN and/or MVCHAIN operation. Also, the interface circuitry 102 may access, read data, and/or write data from/to the registers 104. Also, the interface circuitry 102 can cause and/or instruct the data write interface(s) 106 to write data to the memory 112. The interface circuitry 102 can likewise cause and/or instruct the data read interface(s) 108 to read and/or access data from the memory 112.

The logic circuitry 202 of FIG. 2 executes operations based on a chained-load instruction. For example, when executing a chained-load instruction, the logic circuitry 202 determines the least significant bit values of the address of the memory 112 to access data from. For example, for a 4 byte load, the logic circuitry 202 determines the least 2 significant bits for the 32-bit address. As further described below, the comparator circuitry 204 compares the least significant bit values to preset values to determine how aligned or unaligned the data being accessed is with respect to the alignment of the memory 112. In this manner, the data loading circuitry 206 can store the 4-byte data from the memory 112 in the 8-byte register based on the result of the comparison. Because the processing unit 100 and/or the memory 112 may restrict unaligned memory access, the logic circuitry 202 zeros out the two least significant bits of the address from the operand of the LDCHAIN instruction to perform an aligned memory access. To zero out the least significant bits the logic circuitry 202 using a logic AND operation (e.g., using a logical AND gate) based on the memory address and a preset value (e.g., 0xfffffffc in hexadecimal). The value is the same length as the address with Is for every value except for the least two significant bits, which will have values of 0. Thus, performing a logical AND operation with the value will zero out the two least significant bits of the address while maintaining the rest of the values of the address. Also, for a MVCHAIN instruction, the logic circuitry 202 determines how aligned or unaligned the data to be moved is based on the TDM3 and TDM2 value of the ESTS register. Accordingly, the logic circuitry 202 accesses the TDM3 and TDM2 value from the ESTS register so that the comparator circuitry 204 can determine how aligned or unaligned the data is and the data loading circuitry 206 can store the data in the destination register accordingly. In some examples, the ADDR1 operand of the LDCHAIN instruction may include a variable address that is incremented for each subsequently executed LDCHAIN instruction. In such examples, the logic circuitry 202 can initialize the pointer to the initial address from the ADDR1 operand and increment the pointer value for each subsequent LDCHAIN operation. The pointer value may be incremented by a number corresponding to the size of the memory access. For example, if the data read interface(s) 108 perform(s) a 4-byte access from memory 112, the logic circuitry 202 can increment the counter by 4 after each LDCHAIN operation. Thus, each subsequent LDCHAIN operation will access a data from the memory 112 that does not overlap with the data of accessed during a previous LDCHAIN operation.

The comparator circuitry 204 of FIG. 2, during a LDCHAIN operation (when the LDCHAIN instruction is executed), compares the least significant values of the address to preset value(s). For example, for a 32 bit load operation, the comparator circuitry 204 compares the two least significant bits of the address identified in the 32 bit load operation to 00, 01, 10, 11 to determine whether the 2 least significant bits are 00, 01, 10, or 11. If the least significant bits are 00, the comparator circuitry 204 determines that the 32-bit data is aligned. If the least significant bits are 01, the comparator circuitry 204 determines that the 32-bit data is unaligned by 1 byte. If the least significant bits are 10, the comparator circuitry 204 determines that the 32-bit data is unaligned by 2 bytes. If the least significant bits are 11, the comparator circuitry 204 determines that the 32-bit data is unaligned by 3 bytes. Also, the comparator circuitry 204, during a MVCHAIN operation (e.g., when the MVCHAIN instruction is executed), compares the TDM2 and TDM3 values to the preset value(s). For example, for a 32 bit move operation, the comparator circuitry 204 compares the TDM3 and TDM2 values to 00, 01, 10, 11. If TDM3 value is 0 and the TDM2 value is 0, the comparator circuitry 204 determines that the 32-bit data is aligned. If TDM3 value is 0 and the TDM2 value is 1, the comparator circuitry 204 determines that the 32-bit data is unaligned by 1 byte. If TDM3 value is 1 and the TDM2 value is 0, the comparator circuitry 204 determines that the 32-bit data is unaligned by 2 bytes. If TDM3 value is 1 and the TDM2 value is 1, the comparator circuitry 204 determines that the 32-bit data is unaligned by 2 bytes.

The data loading circuitry 206 of FIG. 2 loads data into a destination register based on the LDCHAIN and/or MVCHAIN instruction and based on the alignment of the data in the source memory and/or source register. For example, for a LDCHAIN operation, if the data is aligned (e.g., the least significant bits of the address operand is 00), the data loading circuitry 206 moves the data from the higher byte locations of the register into the lower byte locations and stores the accessed data into the higher byte locations. For example, for a 64-bit register, the data loading circuitry 206 moves the data stored in locations corresponding to bytes 4-7 to the locations corresponding to bytes 0-3 and stores the accessed 4 bytes from memory into the locations corresponding to bytes 4-7. If the data is unaligned by one byte (e.g., the least significant bits of the address operand is 01), the data loading circuitry 206 moves the data from the higher byte locations of the register shifted by 1 byte into the lower byte locations and stores the accessed data into the higher byte locations shifted by 1 byte. For example, for a 64-bit register, the data loading circuitry 206 moves the data stored in locations corresponding to bytes 4-6 to the locations corresponding to bytes 0-2 and stores the accessed 4 bytes from memory into the locations corresponding to bytes 3-6. If the data is unaligned by two bytes (e.g., the least significant bits of the address operand is 10), the data loading circuitry 206 moves the data from the higher byte locations of the register shifted by 2 bytes into the lower byte locations and stores the accessed data into the higher byte locations shifted by 2 bytes. For example, for a 64-bit register, the data loading circuitry 206 moves the data stored in locations corresponding to bytes 4-5 to the locations corresponding to bytes 0-1 and stores the accessed 4 bytes from memory into the locations corresponding to bytes 2-5. If the data is unaligned by three bytes (e.g., the least significant bits of the address operand is 11), the data loading circuitry 206 moves the data from the higher byte locations of the register shifted by 3 bytes into the lower byte location and stores the accessed data into the higher byte locations shifted by 3 bytes. For example, for a 64-bit register, the data loading circuitry 206 moves the data stored in locations corresponding to byte 4 to the locations corresponding to bytes 0 and stores the accessed 4 bytes from memory into the locations corresponding to bytes 1-4.

For a MVCHAIN operation, if the data is aligned and/or is configured to be aligned (e.g., TDM3 is 0 and TDM2 is 0), the data loading circuitry 206 stores the accessed data from the source register starting from the lowest byte locations of the destination register. For example, for a destination 64-bit register when moving 32 bits of data, the data loading circuitry 206 stores the accessed 4 bytes from the source register into the locations of the destination register that correspond to bytes 0-3. If the data in the source register is unaligned by one byte and/or is configured to be unaligned by one byte (e.g., TDM3 is 0 and TDM2 is 1), the data loading circuitry 206 moves the data from the lowest byte of the higher byte locations of the destination register into the lowest byte location and stores the data from the source register into the next lowest bytes of the destination register. For example, for a destination 64-bit register, the data loading circuitry 206 moves the data stored in locations corresponding to byte 4 to the locations corresponding to byte 0 and stores the 4 bytes from the source register into the locations corresponding to bytes 1-4. If the data in the source register is unaligned by two bytes and/or is configured to be unaligned by two bytes (e.g., TDM3 is 1 and TDM2 is 0), the data loading circuitry 206 moves the data from the lowest two bytes of the higher byte locations of the destination register into the lowest two bytes locations and stores the data from the source register into the next lowest bytes of the destination register. For example, for a destination 64-bit register, the data loading circuitry 206 moves the data stored in locations corresponding to bytes 4 and 5 to the locations corresponding to bytes 0 and 1 and stores the 4 bytes from the source register into the locations corresponding to bytes 2-5. If the data in the source register is unaligned by three bytes and/or is configured to be unaligned by three bytes (e.g., TDM3 is 1 and TDM2 is 1), the data loading circuitry 206 moves the data from the lowest three bytes of the higher byte locations of the destination register into the lowest three bytes locations and stores the data from the source register into the next lowest bytes of the destination register. For example, for a destination 64-bit register, the data loading circuitry 206 moves the data stored in locations corresponding to bytes 4-6 to the locations corresponding to bytes 0-2 and stores the 4 bytes from the source register into the locations corresponding to bytes 3-6.

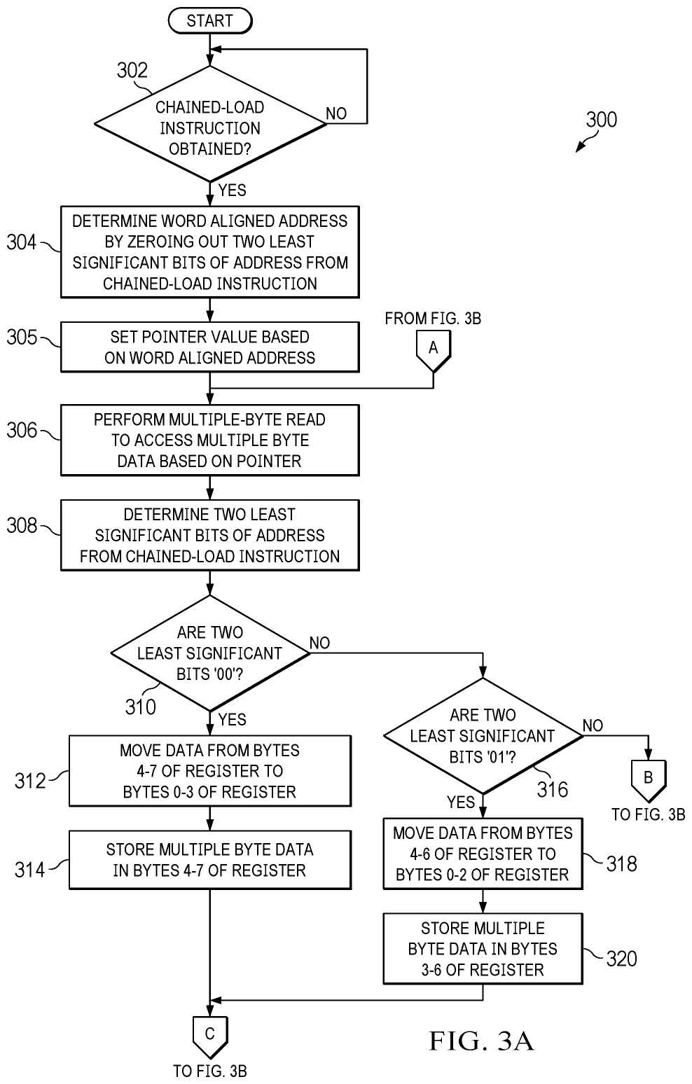

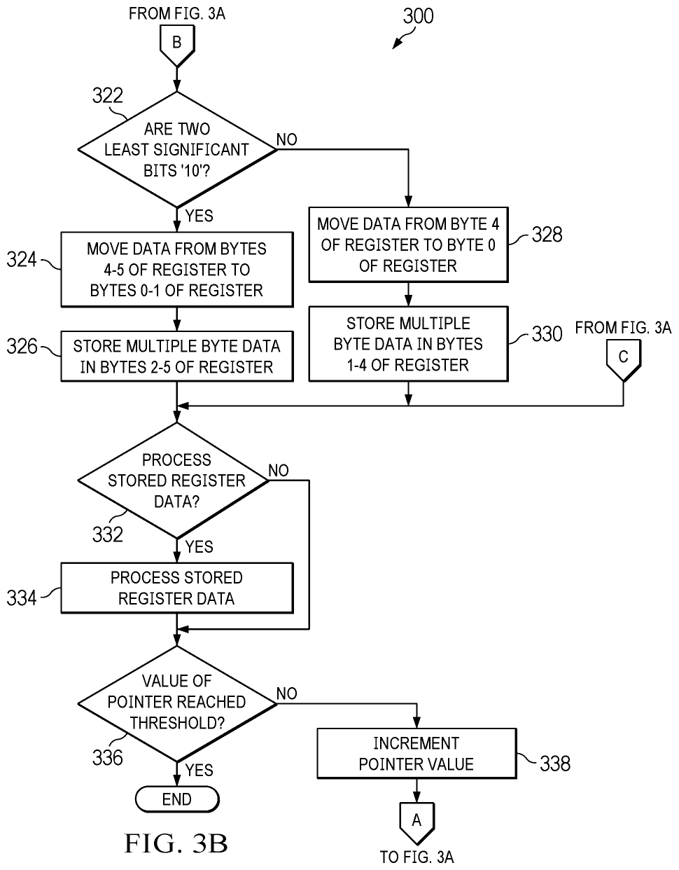

FIGS. 3A-3B illustrate a flowchart representative of a method and/or example operations 300 that may be executed and/or instantiated by processor circuitry or any other circuitry of the decoder 110 of FIG. 2 to perform a LDCHAIN operation corresponding to a LDCHAIN instruction. The example method and/or operations 300 correspond to loading a 32-bit word from the memory 112 into a 64-bit register of the registers 104. However, the flowchart of FIGS. 3A and/or 3B can be adjusted to load any multi byte word into any multi-byte register with slight modifications.

The machine-readable instructions and/or the operations 300 of FIGS. 3A-3B begin at block 302, at which the logic circuitry 202 determines if a chained-load instruction has been obtained via the interface circuitry 200. If the logic circuitry 202 determines that a chained-load instruction has not been obtained (block 302: NO), control returns to block 302 until a load instruction has been obtained. If the logic circuitry 202 determines that a chained-load instruction has been obtained (block 302: YES), the logic circuitry 202 determines a word aligned address for the chained-load instruction by zeroing out the two least significant bits of the address from the chained-load instruction (block 304). For example, the logic circuitry 202 may perform a logical AND operation using the address of the memory to access and a number of the same length as the address with the least significant two bits being 00 and the remaining bits being 1. At block 305, the sets a pointer value based on the word aligned address. The pointer value corresponds to the location of memory where the multi-byte memory access will occur as part of the chained-load operation. At block 306, the logic circuitry 202 causes the data read interface(s) 108 to perform a multiple-byte read to access multiple-byte data (e.g., 4 byte data) based on the pointer. For example, if the pointer corresponds to address location “XXXX0000,” the data read interface(s) 108 access 4 bytes of data starting from the “XXXX0000” address location of the memory 112.

At block 308, the logic circuitry 202 determines the values of the least two significant bits of the address from the chained-load. As described above, the least two significant bits correspond to the alignment of the data in the location of the memory 112 referenced in the chained-load instruction. At block 310, the example comparator circuitry 204 compares the least two significant bits to ‘00’ to determine if the least two significant bits are ‘00.’ If the example comparator circuitry 204 determines that the least two significant bits are not ‘00’ (block 310: NO), control continues to block 316, as further described below. If the example comparator circuitry 204 determines that the least two significant bits are ‘00’ (block 310: YES), the data loading circuitry 206 moves the data stored in bytes 4-7 of the destination register to bytes 0-3 of the destination register (block 312). At block 314, the example data loading circuitry 206 stores the multiple accessed/read byte from the memory 112 into bytes 4-7 of the destination register. After block 314, control continues to block 332 of FIG. 3B, as further described below.

At block 316, the example comparator circuitry 204 compares the least two significant bits to ‘01’ to determine if the least two significant bits are ‘01.’ If the example comparator circuitry 204 determines that the least two significant bits are not ‘01’ (block 316: NO), control continues to block 312 of FIG. 3B, as further described below. If the example comparator circuitry 204 determines that the least two significant bits are ‘01’ (block 316: YES), the data loading circuitry 206 moves the data stored in bytes 4-6 of the destination register to bytes 0-2 of the destination register (block 318). At block 320, the example data loading circuitry 206 stores the multiple accessed/read byte from the memory 112 into bytes 3-6 of the destination register. After block 320, control continues to block 332 of FIG. 3B, as further described below.

At block 322 of FIG. 3B, the example comparator circuitry 204 compares the least two significant bits to ‘10’ to determine if the least two significant bits are ‘10.’ If the example comparator circuitry 204 determines that the least two significant bits are not ‘10’ (block 322: NO), the comparator circuitry 204 determines that the least two significant bits are ‘11’ and control continues to block 328 of FIG. 3B, as further described below. If the example comparator circuitry 204 determines that the least two significant bits are ‘10’ (block 332: YES), the data loading circuitry 206 moves the data stored in bytes 4-5 of the destination register to bytes 0-1 of the destination register (block 324). After block 326, control continues to block 332, as further described below. At block 326, the example data loading circuitry 206 stores the multiple accessed/read byte from the memory 112 into bytes 2-5 of the destination register. At block 328, the data loading circuitry 206 moves the data stored in byte 4 of the destination register to byte 0 of the destination register. At block 330, the example data loading circuitry 206 stores the multiple accessed/read byte from the memory 112 into byte 1-4 of the destination register.

At block 332, the functional unit circuitry 102 determines if the data stored in the register is to be processed. The functional unit circuitry 102 determines if the data stored in the register is to be processed based on if an instruction to process the stored register data has been obtained. In some examples, the data in the register is processed after each chained loaded operation ends. In some examples, the data in the register is not processed after the initial chain-loaded operation and the data in the register is processed after each subsequent chain-loaded operation. If the functional unit circuitry 102 determines that the data stored in the register is not to be processed (block 332: NO), control continues to block 336. If the functional unit circuitry 102 determines that the data stored in the register is to be processed (block 332: YES), the functional unit circuitry 102 processes the stored register data (block 334). The functional unit circuitry 102 may process the stored register data by manipulating the data, storing the data in another location (e.g., another register or another address in the memory 112), comparing the data in the register to other data, sorting the data in the register, etc.

At block 336, the example comparator 204 determines if the pointer has reached a threshold. The threshold corresponds to the number of loaded-chain instructions that will be executed as part of the instructions. The threshold may be defined by a user and/or manufacturer. If the comparator 204 determines that the pointer has reached the threshold (block 336: YES), the instructions end. If the comparator 204 determines that the pointer has not reached the threshold (block 336: NO), the logic circuitry 202 increments the pointer value (block 338) for a subsequent aligned word address and control returns to block 306 of FIG. 3A to execute a subsequent chain-loaded instruction based on the incremented pointer.

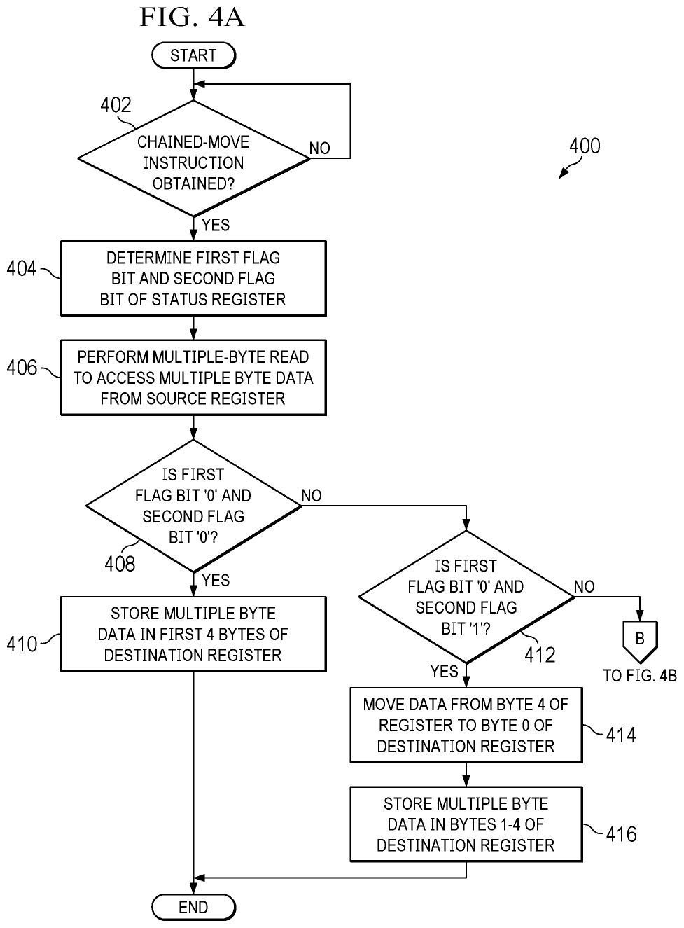

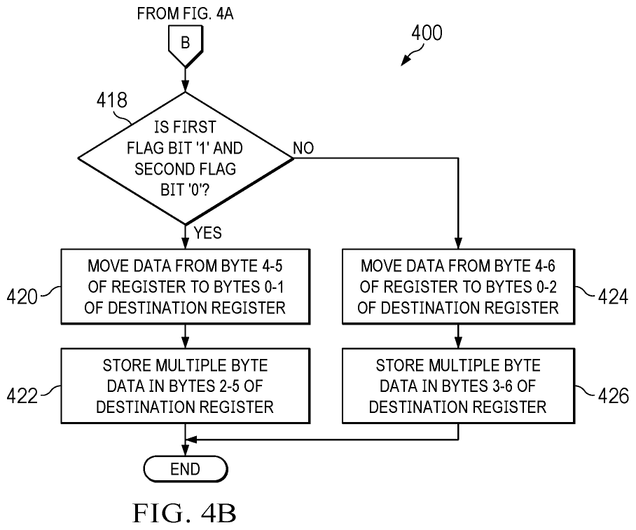

FIGS. 4A-4B illustrate a flowchart representative of a method and/or example operations 400 that may be executed and/or instantiated by processor circuitry or any other circuitry of the decoder 110 of FIG. 2 to perform a MVCHAIN operation corresponding to a MVCHAIN instruction. The example method and/or operations 400 correspond to loading a 32-bit word from a 32-bit source register of the registers 104 into a 64-bit destination register of the registers 104. However, the flowchart of FIGS. 4A and/or 4B can be adjusted to load any multi-byte word into any multi-byte register with slight modifications.

The machine-readable instructions and/or the operations 400 of FIGS. 4A-4B begin at block 402, at which the logic circuitry 202 determines if a chained-move instruction has been obtained via the interface circuitry 200. If the logic circuitry 202 determines that a chained-move instruction has not been obtained (block 402: NO), control returns to block 402 until a move instruction has been obtained. If the logic circuitry 202 determines that a chained-move instruction has been obtained (block 402: YES), the logic circuitry 202 determines a first flag bit value of a first location (e.g., TDM3) in an ESTS register and a second flag bit value of a second location (e.g., TDM2) in an ESTS register (block 404). As further described above, the first flag bit value and the second flag bit value reflect the alignment of the data stored in the source register. At block 406, the logic circuitry 202 performs a multiple-byte read to access multiple-byte data (e.g., 4 byte data) from the source register.

At block 408, the example comparator circuitry 204 compares the first flag bit value and the second flag bit value to the values ‘00’ to determine if the first flag bit value is ‘0’ and the second flag bit value is ‘0.’ If the example comparator circuitry 204 does not determine that the first flag bit value is ‘0’ and the second flag bit value is ‘0’ (block 408: NO), control continues to block 412, as further described below. If the example comparator circuitry 204 determines that the first flag bit value is ‘0’ and the second flag bit value is ‘0’ (block 408: YES), the data loading circuitry 206 stores the read/accessed multiple-byte data into the first 4 bytes (e.g., bytes 0-3) of the destination register (block 410).

At block 412, the example comparator circuitry 204 compares the first flag bit value and the second flag bit value to the values ‘01’ to determine if the first flag bit value is ‘0’ and the second flag bit value is ‘1.’ If the example comparator circuitry 204 does not determine that the first flag bit value is ‘0’ and the second flag bit value is ‘1’ (block 412: NO), control continues to block 418 of FIG. 4B, as further described below. If the example comparator circuitry 204 determines that the first flag bit value is ‘0’ and the second flag bit value is ‘1’ (block 412: YES), the data loading circuitry 206 moves the data stored in byte 4 of the destination register to byte 0 of the destination register (block 414). At block 416, the example data loading circuitry 206 stores the multiple accessed/read byte from the source register into bytes 1-4 of the destination register.

At block 418, the example comparator circuitry 204 compares the first flag bit value and the second flag bit value to the values ‘10’ to determine if the first flag bit value is ‘l’ and the second flag bit value is ‘0.’ If the example comparator circuitry 204 does not determine that the first flag bit value is ‘1’ and the second flag bit value is ‘0’ (block 418: NO), the comparator circuitry 204 determines that the first flag bit value is ‘1’ and the second flag bit value is ‘1’ and control continues to block 424, as further described below. If the example comparator circuitry 204 determines that the first flag bit value is ‘1’ and the second flag bit value is ‘0’ (block 412: YES), the data loading circuitry 206 moves the data stored in bytes 4-5 of the destination register to bytes 0-1 of the destination register (block 420). At block 422, the example data loading circuitry 206 stores the multiple accessed/read byte from the source register into bytes 2-5 of the destination register. At block 424, the data loading circuitry 206 moves the data stored in bytes 4-6 of the destination register to bytes 0-2 of the destination register. At block 426, the example data loading circuitry 206 stores the multiple accessed/read byte from the source register into bytes 3-6 of the destination register.

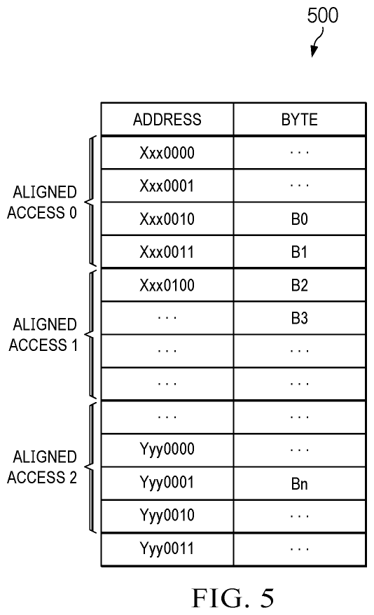

FIG. 5 illustrates an example representation of data stored in memory 500. The memory 500 can correspond to the memory 112 of FIG. 1. The memory 500 includes addresses for locations that store one byte of information. For example, address Xxxx0010 of the memory 500 stores byte B0, location Xxxx0011 of the memory 500 stores byte B1, . . . and location Yyyy0001 of the memory 500 stores byte Bn.

As described above, when the data read interface(s) 108 of the processing unit 100 perform a multi-byte read access (e.g., to read multiple bytes from the memory 500 in a single cycle or access), the processing unit 100 and/or the memory 112 is structured to be able to perform memory aligned read accesses. However, the first portion of the bit stream corresponding to the first aligned access (aligned access 0) is unaligned by two bytes (e.g., the first byte B0 is stored two bytes after the aligned address of Xxx0000). As described above, an aligned memory access means that the interface can read N (e.g., 4) bytes of data starting at an address that is evenly divisible by N. If the processing unit 100 is attempting to access the bit stream corresponding to bytes B0-Bn, the data read interface(s) 108 has to perform multiple multi-byte read operations. The first read operation corresponds to the aligned access 0 which accesses the bytes from addresses Xxx0000-Xxx0011, which includes B0, and B1. Even though the information in addresses Xxx0000, Xxx0001 are not part of the bit stream, the structure/operation of the processing unit 100 and/or the memory 112 accesses the data in those locations as part of the initial aligned data access. However, when the chained-load instruction is executed a second time, the bitstream data B0, B1 will be moved to the most significant bits of the register and the bytes B2-B5 will be stored into the next most significant bits. Thus, the example decoder 110 performs the chained-load operation twice (e.g., an initial chained-load operation based on the initial address location and a second chained-load operation based on an incremented address location) in order to get the bitstream data B0-B5 correctly aligned in a destination register regardless of the alignment of the bit stream. An example of the result of multiple chained-load instructions to ensure that multiple bytes of data obtained via a multi-byte read instruction is aligned in the destination register is further described below in conjunction with FIG. 6.

FIG. 6 illustrates example results of an execution of two chained-load instructions with different alignment of the data being accessed from the memory 112, 500 to a 64-bit register with a variable address operand. FIG. 6 includes results 600 of a single chained-load operation and results 602 after two chained-load operations performed for the subsequent memory locations (e.g., the pointer is incremented after the first chained-load operation). Although the example of FIG. 6 corresponds to a 4-byte read, access, and/or load from memory into an 8-byte register, the size of the read and/or the size of the register can correspond to a different number of bytes. In the example of FIG. 6, XDx [A,B] corresponds to the values in the bit locations B-A in the XDx destination register, Mem [C,D] corresponds to the values in the bit locations D-C in the memory, Addr [Z], corresponds to the value of the memory address at the Z bit, and—corresponds to a value that is not significant for the description of FIG. 6 and can be replaced with any 8 bit value.

The results 600 of FIG. 6 illustrates how 4 byte data accessed from the memory 112, 500 is stored in a 8 byte register when (i) the 4 byte data is aligned (e.g., Addr [1]=0 and Addr [0]=0), (ii) the 4 byte data is unaligned by 1 byte (e.g., Addr [1]=0 and Addr [0]=1), (iii) the 4 byte data is unaligned by 2 bytes (e.g., Addr [1]=1 and Addr [0]=0), and (iv) the 4 byte data is unaligned by 3 bytes (e.g., Addr [1]=1 and Addr [0]=1). As described above, when the memory address identified in the LDCHAIN instruction is aligned, the decoder 110 moves the data in the 4 most significant bytes of the register to the 4 least significant bytes of the register. For example, the decoder 110 moves (i) the data in byte 4 (e.g., XDx [39:32]) of the register to byte 0 (e.g., XDx [7:0]) of the register, (ii) the data in byte 5 (e.g., XDx [47:40]) of the register to byte 1 (e.g., XDx [15:8]) of the register, (iii) the data in byte 6 (e.g., XDx [55:48]) of the register to byte 2 (e.g., XDx [23:16]) of the register, and (iv) the data in byte 7 (e.g., XDx [63:56]) of the register to byte 4 (e.g., XDx [31:24]) of the register. After the data is moved in the register, the decoder 110 stores the data accessed from the memory 112, 500 in the highest 4 bytes. For example, the decoder 110 stores (i) the data in the first byte accessed during the aligned memory access (e.g., Mem [7:0]) to byte 4 (e.g., XDx [39:32]) of the register, (ii) the data in the second byte accessed during the aligned memory access (e.g., Mem [15:8]) to byte 5 (e.g., XDx [47:40]) of the register, (iii) the data in the third byte accessed during the aligned memory access (e.g., Mem [23:16]) to byte 6 (e.g., XDx [55:48]) of the register, and (iv) the data in the third byte accessed during the aligned memory access (e.g., Mem [31:24]) to byte 7 (e.g., XDx [63:56]) of the register.

When the memory address identified in the LDCHAIN instruction is unaligned by 1 byte, the decoder 110 moves (i) the data in byte 4 (e.g., XDx [39:32]) of the register to byte 0 (e.g., XDx [7:0]) of the register, (ii) the data in byte 5 (e.g., XDx [47:40]) of the register to byte 1 (e.g., XDx [15:8]) of the register, and (iii) the data in byte 6 (e.g., XDx [55:48]) of the register to byte 2 (e.g., XDx [23:16]) of the register. After the data is moved in the register, the decoder 110 stores (i) the data in the first byte accessed during the aligned memory access (e.g., Mem [7:0]) to byte 3 (e.g., XDx [31:24]) of the register, (ii) the data in the second byte accessed during the aligned memory access (e.g., Mem [15:8]) to byte 4 (e.g., XDx [39:32]) of the register, (iii) the data in the third byte accessed during the aligned memory access (e.g., Mem [23:16]) to byte 5 (e.g., XDx [40:47]) of the register, and (iv) the data in the third byte accessed during the aligned memory access (e.g., Mem [31:24]) to byte 6 (e.g., XDx [55:48]) of the register.

When the memory address identified in the LDCHAIN instruction is unaligned by 2 bytes, the decoder 110 moves (i) the data in byte 4 (e.g., XDx [39:32]) of the register to byte 0 (e.g., XDx [7:0]) of the register and (ii) the data in byte 5 (e.g., XDx [47:40]) of the register to byte 1 (e.g., XDx [15:8]) of the register. After the data is moved in the register, the decoder 110 stores (i) the data in the first byte accessed during the aligned memory access (e.g., Mem [7:0]) to byte 2 (e.g., XDx [23:16]) of the register, (ii) the data in the second byte accessed during the aligned memory access (e.g., Mem [15:8]) to byte 3 (e.g., XDx [31:24]) of the register, (iii) the data in the third byte accessed during the aligned memory access (e.g., Mem [23:16]) to byte 4 (e.g., XDx [39:42]) of the register, and (iv) the data in the fourth byte accessed during the aligned memory access (e.g., Mem [31:24]) to byte 5 (e.g., XDx [47:40]) of the register.

When the memory address identified in the LDCHAIN instruction is unaligned by 3 bytes, the decoder 110 moves (i) the data in byte 4 (e.g., XDx [39:32]) of the register to byte 0 (e.g., XDx [7:0]) of the register. After the data is moved in the register, the decoder 110 stores (i) the data in the first byte accessed during the aligned memory access (e.g., Mem [7:0]) to byte 1 (e.g., XDx [15:8]) of the register, (ii) the data in the second byte accessed during the aligned memory access (e.g., Mem [15:8]) to byte 2 (e.g., XDx [23:16]) of the register, (iii) the data in the third byte accessed during the aligned memory access (e.g., Mem [23:16]) to byte 3 (e.g., XDx [31:24]) of the register, and (iv) the data in the fourth byte accessed during the aligned memory access (e.g., Mem [31:24]) to byte 4 (e.g., XDx [39:32]) of the register.

The example 602 of FIG. 2 corresponds to executing a second chained-load operation using a subsequent aligned word address (e.g., where the pointer is incremented by 4) and the same destination register resulting in an aligned byte stream, even when the data from the memory address is unaligned. For example, as shown in the example results 600, when the data is aligned (e.g., when Addr [1]=Addr [0]=0), the data from the memory is already stored in bytes 4-7 of the register after the first chained-load operation. In such an example, when the second chained-load operation occurs, as shown in the results 602, the decoder 110 moves the data from bytes 4-7 of the register (e.g., corresponding to the 4-byte data from the memory) to bytes 0-3. Accordingly, after the second chained-load operation ends, the 4 bytes from the memory are aligned in the least significant bits of the register. For example, the 0^{th} byte of the memory (e.g., Mem [7:0]) is stored in the 0^{th} byte of the register (e.g., XDx [7:0]), the 1^{st} byte of the memory (e.g., Mem [15:8]) is stored in the 1^{st} byte of the register (e.g., XDx [15:8]), the 2^{nd} byte of the memory (e.g., Mem [23:16]) is stored in the 2^{nd} byte of the register (e.g., XDx [23:16]), and the 3^{rd} byte of the memory (e.g., Mem [31:24]) is stored in the 3^{rd} byte of the register (e.g., XDx [31:24]). Also, after the first chained-load operation occurs, the pointer for the memory address for the second-load operation is incremented by a value of 4. Accordingly, when the second chained-load operation occurs, the decoder 110 stores 4 bytes of data from the memory 112, based on the incremented pointer, in the highest 4 bytes of the register. For example, the decoder 110 stores (i) the data in the first byte accessed during the aligned memory access (e.g., Mem [39:32]) to byte 4 (e.g., XDx [39:32]) of the register, (ii) the data in the second byte accessed during the aligned memory access (e.g., Mem [47:40]) to byte 5 (e.g., XDx [47:40]) of the register, (iii) the data in the third byte accessed during the aligned memory access (e.g., Mem [55:48]) to byte 6 (e.g., XDx [55:48]) of the register, and (iv) the data in the third byte accessed during the aligned memory access (e.g., Mem [63:56]) to byte 7 (e.g., XDx [63:56]) of the register.

As shown in the example results 600, when the data is unaligned by one byte (e.g., when Addr [1]=0 and Addr [0]=1), the data from the memory is already stored in bytes 3-6 of the register after the first chained-load operation. In such an example, when the second chained-load operation occurs, as shown in the results 602, the decoder 110 moves the data from bytes 4-6 of the register (e.g., corresponding to the 3 unaligned bytes of data from the memory) to bytes 0-2. Accordingly, after the second chained-load operation ends, the 3 unaligned bytes from the memory are aligned in the least significant bytes of the register. For example, the 1^{st} byte of the memory (e.g., Mem [15:8]) is stored in the 0^{th} byte of the register (e.g., XDx [7:0]), the 2^{nd} byte of the memory (e.g., Mem [23:16]) is stored in the 1^{st} byte of the register (e.g., XDx [15:8]), and the 3^{rd} byte of the memory (e.g., Mem [31:24]) is stored in the 2^{nd} byte of the register (e.g., XDx [23:16]). Because the data in the memory is unaligned by 1 byte, the 0^{th} byte of the memory (e.g., Mem [7:0]) is not relevant as the data of interest starts 1 byte after the aligned 0^{th} byte of the memory. Thus, the first byte of interest of the memory (e.g., Mem [15:8]) is stored in the 0^{th} byte of the register, as shown in result 602. Also, after the first chained-load operation occurs, the pointer for the memory address for the second-load operation is incremented by a value of 4. Accordingly, when the second chained-load operation occurs, the decoder 110 stores 4 bytes of data from the memory 112, based on the incremented pointer, in the register. For example, the decoder 110 stores (i) the data in the first byte accessed during the aligned memory access (e.g., Mem [39:32]) to byte 3 (e.g., XDx [31:24]) of the register, (ii) the data in the second byte accessed during the aligned memory access (e.g., Mem [47:40]) to byte 4 (e.g., XDx [39:32]) of the register, (iii) the data in the third byte accessed during the aligned memory access (e.g., Mem [55:48]) to byte 5 (e.g., XDx [40:47]) of the register, and (iv) the data in the fourth byte accessed during the aligned memory access (e.g., Mem [63:56]) to byte 6 (e.g., XDx [55:48]) of the register.

As shown in the example results 600, when the data is unaligned by two bytes (e.g., when Addr [1]=1 and Addr [0]=0), the data from the memory is already stored in bytes 2-5 of the register after the first chained-load operation. In such an example, when the second chained-load operation occurs, as shown in the results 602, the decoder 110 moves the data from bytes 4-5 of the register (e.g., corresponding to the 2 unaligned bytes of data from the memory) to bytes 0-1. Accordingly, after the second chained-load operation ends, the 2 unaligned bytes from the memory are aligned in the least significant bytes of the register. For example, the 2^{nd} byte of the memory (e.g., Mem [23:16]) is stored in the 0^{th} byte of the register (e.g., XDx [7:0]) and the 3^{rd} byte of the memory (e.g., Mem [31:24]) is stored in the 1^{st} byte of the register (e.g., XDx [15:8]). Because the data in the memory is unaligned by 2 bytes, the 0^{th} and 1^{st} byte of the memory (e.g., Mem [7:0] and Mem [14:8]) are not relevant as the data of interest starts 2 bytes after the aligned 0^{th} byte of the memory. Thus, the first byte of interest of the memory (e.g., Mem [23:16]) is stored in the 0^{th} byte of the register, as shown in result 602. Also, after the first chained-load operation occurs, the pointer for the memory address for the second-load operation is incremented by a value of 4. Accordingly, when the second chained-load operation occurs, the decoder 110 stores 4 bytes of data from the memory 112, based on the incremented pointer, in the register. For example, the decoder 110 stores (i) the data in the first byte accessed during the aligned memory access (e.g., Mem [39:32]) to byte 2 (e.g., XDx [23:16]) of the register, (ii) the data in the second byte accessed during the aligned memory access (e.g., Mem [47:40]) to byte 3 (e.g., XDx [31:24]) of the register, (iii) the data in the third byte accessed during the aligned memory access (e.g., Mem [55:48]) to byte 4 (e.g., XDx [39:42]) of the register, and (iv) the data in the fourth byte accessed during the aligned memory access (e.g., Mem [63:56]) to byte 3 (e.g., XDx [47:40]) of the register.

As shown in the example results 600, when the data is unaligned by three bytes (e.g., when Addr [1]=1 and Addr [0]=1), the data from the memory is already stored in bytes 1-4 of the register after the first chained-load operation. In such an example, when the second chained-load operation occurs, as shown in the results 602, the decoder 110 moves the data from byte 4 of the register (e.g., corresponding to the 1 unaligned bytes of data from the memory) to byte 0. Accordingly, after the second chained-load operation ends, the 1 unaligned byte from the memory is aligned in the least significant byte of the register. For example, the 1^{st} byte of the memory (e.g., Mem [31:24]) is stored in the 0^{th} byte of the register (e.g., XDx [7:0]). Because the data in the memory is unaligned by 3 bytes, the 0^{th}, 1^{st}, 2^{nd} bytes of the memory (e.g., Mem [7:0], Mem [15:8], and Mem [23:16]) are not relevant as the data of interest starts 3 bytes after the aligned 0^{th} byte of the memory. Thus, the first byte of interest of the memory (e.g., Mem [31:24]) is stored in the 0^{th} byte of the register, as shown in result 602. Also, after the first chained-load operation occurs, the pointer for the memory address for the second-load operation is incremented by a value of 4. Accordingly, when the second chained-load operation occurs, the decoder 110 stores 4 bytes of data from the memory 112, based on the incremented pointer, in the register. For example, the decoder 110 stores (i) the data in the first byte accessed during the aligned memory access (e.g., Mem [39:32]) to byte 2 (e.g., XDx [15:8]) of the register, (ii) the data in the second byte accessed during the aligned memory access (e.g., Mem [47:40]) to byte 3 (e.g., XDx [23:16]) of the register, (iii) the data in the third byte accessed during the aligned memory access (e.g., Mem [55:48]) to byte 4 (e.g., XDx [31:24]) of the register, and (iv) the data in the fourth byte accessed during the aligned memory access (e.g., Mem [63:56]) to byte 3 (e.g., XDx [39:32]) of the register.

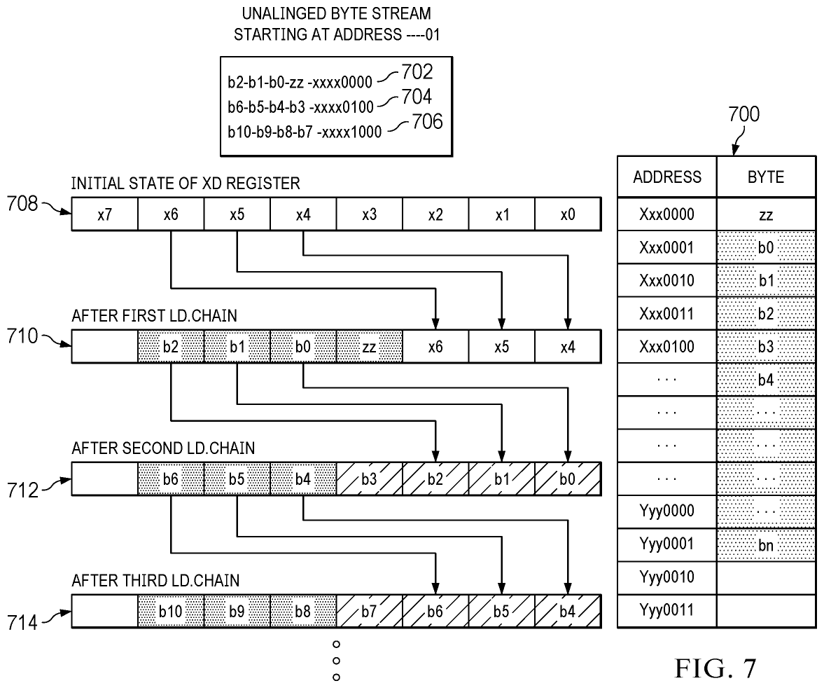

FIG. 7 illustrates the results of the execution of multiple chained-load instruction for data in the memory 112 that is unaligned by 1 byte. FIG. 7 includes an example memory 700 storing data b0-bn. FIG. 7 further includes example data-to-multiple byte read associations 702, 704, 706. FIG. 7 further includes example results 708, 710, 712, 714 of data stored in a register (register XD) before and after one or more LDCHAIN operations. Although the example of FIG. 7 corresponds to 4-byte read operation for each LDCHAIN operation, FIG. 7 could be described in conjunction with any size read operation. Also, although FIG. 7 is described in conjunction with a data that is unaligned by one byte, the data could be aligned or unaligned by a different number of bytes.

As shown in the example memory 700, the data b0-bn is unaligned by one byte. For example, when the data read interface(s) 108 perform(s) a read operation, the data read interface(s) 108 can access four bytes of data at 4-byte increments (e.g., at XXX0000, XXXX0100, XXXX1000, etc.). Because the first byte of the data (b0) doesn't start at one of the 4-byte increments, but rather starts one byte after the 4-byte increment (e.g., XXXX0001), the data stream b0-bn is unaligned by one byte. Thus, as described above, during a first LDCHAIN operation when the pointer is initiated to the aligned location (e.g., the location of the address with the two least significant bits zeroed out), the data read interface(s) 108 will access the data at bytes XXXX0000-XXXX0011 (as shown in the first data-to-multiple byte read association 702).

Initially, the XD register has some information stored in the 8 bytes of the XD register (e.g., all 0s or previously stored data). In the example of FIG. 7, the initial data in the 0^{th} byte of the XD register is x0, the initial data in the 1^{st} byte of the XD register is x1, etc. During the first LDCHAIN operation, the X4, X5, and X6 data in the register is moved to the 0^{th}-2^{nd} byte of the register. After moved, the LDCHAIN operation performs a 4-byte access to the memory 700 to obtain the zz, b0, b1, b2 data from the initial 4 bytes of the word aligned address and stores the obtained zz, b0, b1, b2 data in the 3^{rd}-6^{th} bytes of the register, as shown in the first LDCHAIN result 710. After the first LDCHAIN operation, the pointer is incremented by a value of 4 (e.g., corresponding to memory address XXXX0100). In this manner, a subsequent LDCHAIN operation will include accessing the b3-b6 data in the memory 700 that corresponds to the second data-to-multiple byte read association 704.

During the second LDCHAIN operation, the b0, b1, and b2 data in the register is moved to the 0^{th}-2^{nd} byte of the register. After moved, the LDCHAIN operation performs a 4-byte access to the memory 700 at the location corresponding to the incremented pointer to obtain the b6, b5, b4, and b3 data from the subsequent 4 bytes of the word aligned address and stores the obtained b6, b5, b4, and b3 data in the 3^{rd}-6^{th} bytes of the register, as shown in the second LDCHAIN result 712. Accordingly, after the second LDCHAIN operation, the unaligned data b0-b6 from the memory 700 is stored in the XD register in an aligned manner (e.g., b0 in the 0^{th} byte of the register, b1 in the 1^{st} byte of the register, etc.). The two LDCHAIN operations retrieve and align data b0-b3, and after the second LDCHAIN operation, the functional unit circuitry 102 may process, manipulate, compare, order, and/or move this data in the register. After the second LDCHAIN operation, the pointer is incremented by a value of 4 (e.g., corresponding to memory address XXXX1000). In this manner, a subsequent LDCHAIN operation will include accessing the b7-b10 data in the memory 700 that corresponds to the second data-to-multiple byte read association 706.

During the third LDCHAIN operation, the b4, b5, and b6 data in the register is moved to the 0^{th}-2^{nd} byte of the register. After moved, the LDCHAIN operation performs a 4-byte access to the memory 700 at the location corresponding to the incremented pointer to obtain the b10, b9, b8, and b7 data from the subsequent 4 bytes of the word aligned address and stores the obtained b10, b9, b8, and b7 data in the 3^{rd}-6^{th} bytes of the register, as shown in the second LDCHAIN result 714. Accordingly, after the third LDCHAIN operation, the data b4-b10 from the memory 700 is stored in the XD register in an aligned manner (e.g., b4 in the 0^{th} byte of the register, b5 in the 1^{st} byte of the register, etc.). The single additional LDCHAIN operation retrieves and aligns data b4-b7, and after the third LDCHAIN operation, the functional unit circuitry 102 may process, manipulate, compare, order, and/or move this data in the register. After the third LDCHAIN operation, the pointer is incremented by a value of 4 (e.g., corresponding to memory address XXXX1100). In this manner, a subsequent LDCHAIN operation will include accessing the b11-b14 data in the memory 700.

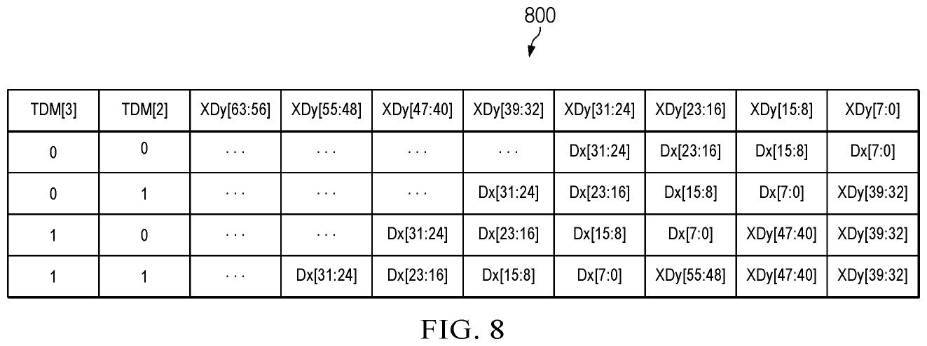

FIG. 8 illustrates example results of a chained-move instruction with different alignment of the data being moved from a 32 bit register to a 64-bit register. FIG. 8 includes results 800 of a single chained-move operation to move the 4-byte data as aligned, unaligned by 1 byte, unaligned by 2 bytes, or unaligned by 3 bytes. Although the example of FIG. 8 corresponds to a 4 byte move from a source register into an 8-byte destination register, the size of the data moved, and/or the sizes of the registers can correspond to a different number of bytes. In the example of FIG. 6, XDy [A,B] corresponds to the values in the byte locations B-A in the XDy destination register, Dx [C,D] corresponds to the values in the bit locations D-C in the source register, TDM[Z], corresponds to the value of stored in the corresponding location of the ESTS register, and—corresponds to a value that is not significant for the description of FIG. 6 and can be replaced with any 8 bit value.

The results 800 of FIG. 8 illustrates how 4 byte data accessed from a source register is stored in a 8 byte destination register when (i) the 4 byte data is aligned (e.g., TDM [3]=0 and TDM [2]=0), (ii) the 4 byte data is unaligned by 1 byte (e.g., TDM [3]=0 and TDM [2]=1), (iii) the 4 byte data is unaligned by 2 bytes (e.g., TDM [3]=1 and TDM [2]=0), and (iv) the 4 byte data is unaligned by 3 bytes (e.g., TDM [3]=1 and TDM [2]=1). For example, when the data to be moved is aligned or is to be stored aligned (e.g., TDM [3]=0 and TDM [2]=0), the decoder 110 stores the data from the source register to the least significant byte of the destination register. For example, the decoder 110 stores the 0^{th} byte from the source Dx register (e.g., Dx [7:0]) in the 0^{th} byte of the destination XDy register (e.g., XDy [7:0]), the 1^{st} byte from the source Dx register (e.g., Dx [15:8]) in the 1^{st} byte of the destination XDy register (e.g., XDy [15:8]), the 2^{nd} byte from the source Dx register (e.g., Dx [23:16]) in the 2^{nd} byte of the destination XDy register (e.g., XDy [23:16]), and the 3^{rd} byte from the source Dx register (e.g., Dx [31:24]) in the 3^{rd} byte of the destination XDy register (e.g., XDy [31:24]).

When the data to be moved is unaligned by one byte or is to be stored unaligned by one byte (e.g., TDM [3]=0 and TDM [2]=1), the decoder 110 moves the data from the 4^{th} byte of the destination register (e.g., XDy [39:32]) to the 0^{th} byte of the destination register (e.g., XDy [7:0]). Also, the decoder 110 stores the data from the source register to the bytes 1-4 of the destination register. For example, the decoder 110 stores the 0^{th} byte from the source Dx register (e.g., Dx [7:0]) in the 1^{st} byte of the destination XDy register (e.g., XDy [15:8]), the 1^{st} byte from the source Dx register (e.g., Dx [15:8]) in the 2^{nd} byte of the destination XDy register (e.g., XDy [23:16]), the 2^{nd} byte from the source Dx register (e.g., Dx [23:16]) in the 3^{rd} byte of the destination XDy register (e.g., XDy [31:24]), and 3^{rd} byte from the source Dx register (e.g., Dx [31:24]) in the 4^{th} byte of the destination XDy register (e.g., XDy [39:32]).

When the data to be moved is unaligned by two bytes or is to be stored unaligned by two bytes (e.g., TDM [3]=1 and TDM [2]=0), the decoder 110 moves the data from the 4^{th} and 5^{th} bytes of the destination register (e.g., XDy [39:32] and XDy [47:40]) to the 0^{th} and 1^{st} bytes of the destination register (e.g., XDy [7:0] and XDy [15:8]). Also, the decoder 110 stores the data from the source register to the bytes 2-5 of the destination register. For example, the decoder 110 stores the 0^{th} byte from the source Dx register (e.g., Dx [7:0]) in the 2^{nd} byte of the destination XDy register (e.g., XDy [23:16]), the 1^{st} byte from the source Dx register (e.g., Dx [15:8]) in the 3^{rd} byte of the destination XDy register (e.g., XDy [31:24]), the 2^{nd} byte from the source Dx register (e.g., Dx [23:16]) in the 4^{th} byte of the destination XDy register (e.g., XDy [39:32]), and 3^{rd} byte from the source Dx register (e.g., Dx [31:24]) in the 5^{th} byte of the destination XDy register (e.g., XDy [47:40]).

When the data to be moved is unaligned by three bytes or is to be stored unaligned by three bytes (e.g., TDM [3]=1 and TDM [2]=1), the decoder 110 moves the data from the 3^{rd}, 4^{th}, and 5^{th} bytes of the destination register (e.g., XDy [39:32], XDy [47:40], XDy [55:48]) to the 0^{th}, 1^{st}, 2^{nd} bytes of the destination register (e.g., XDy [7:0], XDy [15:8], XDy [23:16]). Also, the decoder 110 stores the data from the source register to the bytes 1-4 of the destination register. For example, the decoder 110 stores the 0^{th} byte from the source Dx register (e.g., Dx [7:0]) in the 3^{rd} byte of the destination XDy register (e.g., XDy [31:24]), the 1^{st} byte from the source Dx register (e.g., Dx [15:8]) in the 4^{th} byte of the destination XDy register (e.g., XDy [39:32]), the 2^{nd} byte from the source Dx register (e.g., Dx [23:16]) in the 5^{th} byte of the destination XDy register (e.g., XDy [47:40]), and 3^{rd} byte from the source Dx register (e.g., Dx [31:24]) in the 6^{th} byte of the destination XDy register (e.g., XDy [55:48]).

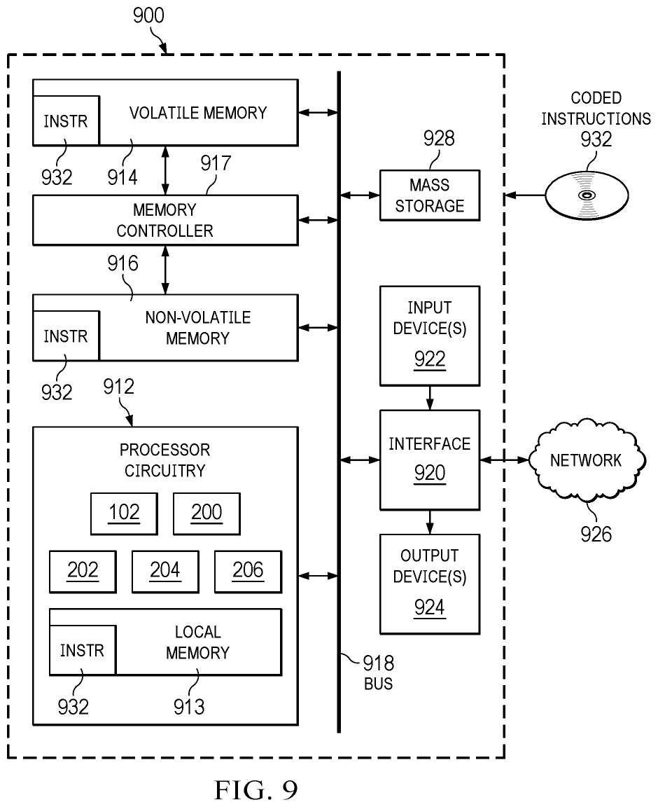

FIG. 9 is a block diagram of an example programmable circuitry platform 900 structured to execute and/or instantiate the example machine-readable instructions and/or the example operations of FIGS. 3A-4B to implement the decoder 110 of FIG. 2. The programmable circuitry platform 900 can be, for example, a server, a personal computer, a workstation, a mobile device (e.g., a cell phone, a smart phone, a tablet such as an iPad™), a personal digital assistant (PDA), an Internet appliance, a headset (e.g., an augmented reality (AR) headset, a virtual reality (VR) headset, etc.) or other wearable device, or any other type of computing and/or electronic device.

The programmable circuitry platform 900 of the illustrated example includes programmable circuitry 912. The programmable circuitry 912 of the illustrated example is hardware. For example, the programmable circuitry 912 can be implemented by one or more integrated circuits, logic circuits, FPGAs, microprocessors, CPUs, GPUs, DSPs, and/or microcontrollers from any desired family or manufacturer. The programmable circuitry 912 may be implemented by one or more semiconductor based (e.g., silicon based) devices. In this example, the programmable circuitry 912 implements the interface circuitry 200, the logic circuitry 202, the comparator circuitry 204, and the data loading circuitry 206 of FIG. 2.

The programmable circuitry 912 of the illustrated example includes a local memory 913 (e.g., a cache, registers, etc.). The programmable circuitry 912 of the illustrated example is in communication with main memory 914, 916, which includes a volatile memory 914 and a non-volatile memory 916, by a bus 918. The volatile memory 914 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 916 may be implemented by flash memory and/or any other desired type of memory device. Access to the main memory 914, 916 of the illustrated example is controlled by a memory controller 917. In some examples, the memory controller 917 may be implemented by one or more integrated circuits, logic circuits, microcontrollers from any desired family or manufacturer, or any other type of circuitry to manage the flow of data going to and from the main memory 914, 916. In some examples, the memory 112, 500 of FIGS. 1 and/or 5 could be implemented by the one or more of the main memories 914, 186.

The programmable circuitry platform 900 of the illustrated example also includes interface circuitry 920. The interface circuitry 920 may be implemented by hardware in any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 922 are connected to the interface circuitry 920. The input device(s) 922 permit(s) a user (e.g., a human user, a machine user, etc.) to enter data and/or commands into the programmable circuitry 912. The input device(s) 922 can be implemented by, for example, an audio sensor, a microphone, a camera (still or video), a keyboard, a button, a mouse, a touchscreen, and/or a voice recognition system.

One or more output devices 924 are also connected to the interface circuitry 920 of the illustrated example. The output device(s) 924 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 920 of the illustrated example, thus, typically includes a graphics driver card, a graphics driver chip, and/or graphics processor circuitry such as a GPU.

The interface circuitry 920 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 926. The communication can be by, for example, an Ethernet connection, a digital subscriber line (DSL) connection, a telephone line connection, a coaxial cable system, a satellite system, a beyond-line-of-sight wireless system, a line-of-sight wireless system, a cellular telephone system, an optical connection, etc.

The programmable circuitry platform 900 of the illustrated example also includes one or more mass storage discs or devices 928 to store firmware, software, and/or data. Examples of such mass storage discs or devices 928 include magnetic storage devices (e.g., floppy disk, drives, HDDs, etc.), optical storage devices (e.g., Blu-ray disks, CDs, DVDs, etc.), RAID systems, and/or solid-state storage discs or devices such as flash memory devices and/or SSDs.

The machine readable instructions 932, which may be implemented by the machine readable instructions of FIGS. 3A-4B, may be stored in the mass storage device 928, in the volatile memory 914, in the non-volatile memory 916, and/or on at least one non-transitory computer readable storage medium such as a CD or DVD which may be removable.

An example manner of implementing the decoder 110 of FIG. 1 is illustrated in FIG. 2. However, one or more of the elements, processes and/or devices illustrated in FIG. 2 may be combined, divided, re-arranged, omitted, eliminated and/or implemented in any other way.

Further, the interface circuitry 200, the logic circuitry 202, the comparator circuitry 204, and/or the data loading circuitry 206 may be implemented by hardware, software, firmware and/or any combination of hardware, software and/or firmware. As a result, for example, any of the interface circuitry 200, the logic circuitry 202, the comparator circuitry 204, and/or the data loading circuitry 206 could be implemented by one or more analog or digital circuit(s), logic circuits, programmable processor(s), programmable controller(s), graphics processing unit(s) (GPU(s)), digital signal processor(s) (DSP(s)), application specific integrated circuit(s) (ASIC(s)), programmable logic device(s) (PLD(s)) and/or field programmable logic device(s) (FPLD(s)).

When reading any of the apparatus or system claims of this patent to cover a purely software and/or firmware implementation, at least one of the interface circuitry 200, the logic circuitry 202, the comparator circuitry 204, and/or the data loading circuitry 206 is/are hereby expressly defined to include a non-transitory computer readable storage device or storage disk such as a memory, a digital versatile disk (DVD), a compact disk (CD), a Blu-ray disk, etc., including the software and/or firmware. Further still, the interface circuitry 200, the logic circuitry 202, the comparator circuitry 204, and/or the data loading circuitry 206 may include one or more elements, processes and/or devices in addition to, or instead of, those illustrated in FIGS. 1-3, and/or may include more than one of any or all of the illustrated elements, processes, and devices. As used herein, the phrase “in communication,” including variations thereof, encompasses direct communication and/or indirect communication through one or more intermediary components, and does not require direct physical (e.g., wired) communication and/or constant communication, but rather also includes selective communication at periodic intervals, scheduled intervals, aperiodic intervals, and/or one-time events.

Flowcharts representative of example hardware logic, machine-readable instructions, hardware implemented state machines, and/or any combination thereof for implementing the decoder 110 of FIGS. 1-2 are shown in FIGS. 3A-4B. The machine-readable instructions may be one or more executable programs or portion(s) of an executable program for execution by a computer processor. The program may be embodied in software stored on a non-transitory computer readable storage medium such as a CD-ROM, a floppy disk, a hard drive, a DVD, a Blu-ray disk, or a memory associated with the processor, but the entire program and/or parts thereof could alternatively be executed by a device other than the processor and/or embodied in firmware or dedicated hardware.

Further, although the example program is described with reference to the flowcharts illustrated in FIG. 3A-4B, many other methods of implementing the decoder 110 may alternatively be used. For example, the order of execution of the blocks may be changed, and/or some of the blocks described may be changed, eliminated, or combined. Also or alternatively, any or all of the blocks may be implemented by one or more hardware circuits (e.g., discrete and/or integrated analog and/or digital circuitry, an FPGA, an ASIC, a comparator, an operational-amplifier (op-amp), a logic circuit, etc.) structured to perform the corresponding operation without executing software or firmware.

The machine-readable instructions described herein may be stored in one or more of a compressed format, an encrypted format, a fragmented format, a compiled format, an executable format, a packaged format, etc. Machine-readable instructions as described herein may be stored as data (e.g., portions of instructions, code, representations of code, etc.) that may be utilized to create, manufacture, and/or produce machine executable instructions. For example, the machine-readable instructions may be fragmented and stored on one or more storage devices and/or computing devices (e.g., servers). The machine-readable instructions may require one or more of installation, modification, adaptation, updating, combining, supplementing, configuring, decryption, decompression, unpacking, distribution, reassignment, compilation, etc. in order to make them directly readable, interpretable, and/or executable by a computing device and/or other machine. For example, the machine-readable instructions may be stored in multiple parts, which are individually compressed, encrypted, and stored on separate computing devices, in which the parts when decrypted, decompressed, and combined form a set of executable instructions that implement a program such as that described herein.

In another example, the machine-readable instructions may be stored in a state in which they may be read by a computer, but require addition of a library (e.g., a dynamic link library (DLL)), a software development kit (SDK), an application programming interface (API), etc. in order to execute the instructions on a particular computing device or other device. In another example, the machine-readable instructions may be configured (e.g., settings stored, data input, network addresses recorded, etc.) before the machine-readable instructions and/or the corresponding program(s) can be executed in whole or in part. As a result, the described machine-readable instructions and/or corresponding program(s) encompass such machine-readable instructions and/or program(s) regardless of the particular format or state of the machine-readable instructions and/or program(s) when stored or otherwise at rest or in transit.

The machine-readable instructions described herein can be represented by any past, present, or future instruction language, scripting language, programming language, etc. For example, the machine-readable instructions may be represented using any of the following languages: C, C++, Java, C#, Perl, Python, JavaScript, HyperText Markup Language (HTML), Structured Query Language (SQL), Swift, etc.

As mentioned above, the example processes of FIGS. 3A-4B may be implemented using executable instructions (e.g., computer and/or machine-readable instructions) stored on a non-transitory computer and/or machine-readable medium such as a hard disk drive, a flash memory, a read-only memory, a compact disk, a digital versatile disk, a cache, a random-access memory and/or any other storage device or storage disk in which information is stored for any duration (e.g., for extended time periods, permanently, for brief instances, for temporarily buffering, and/or for caching of the information). As used herein, the term non-transitory computer readable medium is expressly defined to include any type of computer readable storage device and/or storage disk and to exclude propagating signals and to exclude transmission media.

Example methods, apparatus and articles of manufacture have been described to improve accuracy and/or efficiency of current limit circuitry. The described methods, apparatus and articles of manufacture improve the accuracy and/or efficiency of current limit circuitry using a diode-connected device, a current source, and a gain stage.

Although certain example methods, apparatus and articles of manufacture have been described herein, the scope of coverage of this patent is not limited thereto. On the contrary, this patent covers all methods, apparatus and articles of manufacture fairly falling within the scope of the claims of this patent.

Descriptors “first,” “second,” “third,” etc. are used herein when identifying multiple elements or components which may be referred to separately. Unless otherwise specified or known based on their context of use, such descriptors do not impute any meaning of priority, physical order, or arrangement in a list, or ordering in time but are merely used as labels for referring to multiple elements or components separately for ease of understanding the described examples. In some examples, the descriptor “first” may be used to refer to an element in the detailed description, while the same element may be referred to in a claim with a different descriptor such as “second” or “third.” In such instances, such descriptors are used merely for case of referencing multiple elements or components.

In the description and in the claims, the terms “including” and “having” and variants thereof are to be inclusive in a manner similar to the term “comprising” unless otherwise noted. Unless otherwise stated, “about,” “approximately,” or “substantially” preceding a value means+/−10 percent of the stated value. In another example, “about,” “approximately,” or “substantially” preceding a value means+/−5 percent of the stated value. IN another example, “about,” “approximately,” or “substantially” preceding a value means+/−1 percent of the stated value.

The term “couple”, “coupled”, “couples”, and variants thereof, as used herein, may cover connections, communications, or signal paths that enable a functional relationship consistent with this description. For example, if device A generates a signal to control device B to perform an action, if a first example device A is coupled to device B, or if a second example device A is coupled to device B through intervening component C if intervening component C does not substantially alter the functional relationship between device A and device B, such that device B is controlled by device A via the control signal generated by device A. Moreover, the terms “couple”, “coupled”, “couples”, or variants thereof, includes an indirect or direct electrical or mechanical connection.

A device that is “configured to” perform a task or function may be configured (e.g., programmed and/or hardwired) at a time of manufacturing by a manufacturer to perform the function and/or may be configurable (or re-configurable) by a user after manufacturing to perform the function and/or other additional or alternative functions. The configuring may be through firmware and/or software programming of the device, through a construction and/or layout of hardware components and interconnections of the device, or a combination thereof.

Although not all separately labeled in the FIGS. 1-2, components or elements of systems and circuits illustrated therein have one or more conductors or terminus that allow signals into and/or out of the components or elements. The conductors or terminus (or parts thereof) may be referred to herein as pins, pads, terminals (including input terminals, output terminals, reference terminals, and ground terminals, for instance), inputs, outputs, nodes, and interconnects.

As used herein, a “terminal” of a component, device, system, circuit, integrated circuit, or other electronic or semiconductor component, generally refers to a conductor such as a wire, trace, pin, pad, or other connector or interconnect that enables the component, device, system, etc., to electrically and/or mechanically connect to another component, device, system, etc. A terminal may be used, for instance, to receive or provide analog or digital electrical signals (or simply signals) or to electrically connect to a common or ground reference. Accordingly, an input terminal or input is used to receive a signal from another component, device, system, etc. An output terminal or output is used to provide a signal to another component, device, system, etc. Other terminals may be used to connect to a common, ground, or voltage reference, e.g., a reference terminal or ground terminal. A terminal of an IC or a PCB may also be referred to as a pin (a longitudinal conductor) or a pad (a planar conductor). A node refers to a point of connection or interconnection of two or more terminals. An example number of terminals and nodes may be shown. However, depending on a particular circuit or system topology, there may be more or fewer terminals and nodes. However, in some instances, “terminal”, “node”, “interconnect”, “pad”, and “pin” may be used interchangeably.

Example methods, apparatus, systems, and articles of manufacture corresponding to facilitate unaligned byte stream operations are described herein. Further examples and combinations thereof include the following: Example 1 includes an apparatus comprising a register including a first portion and a second portion, an interface, and a decoder coupled to the register and to the interface and configured to, responsive to obtaining an instruction cause a first set of data to be moved from the first portion of the register to the second portion of the register based on an address identified in the instruction, cause the interface to read a second set of data from an aligned address of a memory, and cause the second set of data to be stored into the register at a location based on the address identified in the instruction.

Example 2 includes the apparatus of example 1, wherein the decoder is to determine least significant bits of the address of the memory corresponding to a load instruction, and determine the aligned address by zeroing out the least significant bits from the address, the aligned address defining the first portion of the register and the second portion of the register.

Example 3 includes the apparatus of example 2, wherein the decoder is to determine the aligned address by performing a logical AND operation using the address and a number.

Example 4 includes the apparatus of example 3, wherein the number includes a value of zero for the least two significant bits and a value of one for the remaining bits of the number.

Example 5 includes the apparatus of example 2, wherein the register includes a first half of bits that correspond to most significant bits of the register and a second half of bits that correspond to least significant bits of the register, and the decoder is configured to, when the least significant bits of the address correspond to zeros cause the first set of data to be moved from the most significant bits of the register to the least significant bits of the register, and cause the second set of data to be stored into the most significant bits of the register.

Example 6 includes the apparatus of example 2, wherein the register includes a first half of bits that correspond to most significant bits of the register and a second half of bits that correspond to least significant bits of the register, and the decoder is configured to, when at least one of the least significant bits of the address corresponds to a one cause the first set of data to be moved from a third portion of the most significant bits of the register to a fourth portion of the least significant bits of the register, and cause the second set of data to be stored in a fifth portion of the register, the fifth portion including the third portion of the most significant bits of the register and a sixth portion of the least significant bits of the register.

Example 7 includes the apparatus of example 1, wherein the address of the memory and an indication of the register are operands of the instruction.

Example 8 includes the apparatus of example 5, wherein the memory stores the data at the address.

Example 9 includes the apparatus of example 5, wherein the decoder is to store the data into the register to execute the instruction.

Example 10 includes the apparatus of example 2, wherein the least significant bits of the address of the memory correspond to an alignment of the data.

Example 11 includes an apparatus comprising logic circuitry configured to determine a first value and a second value stored in a status register, an interface configured to read data from a first register, and data loading circuitry configured to store the data into a second register based on the first value and the second value.

Example 12 includes the apparatus of example 11, wherein the data loading circuitry is to, when the first value and the second value are zero, store the data into the least significant bits of the second register.

Example 13 includes the apparatus of example 11, wherein the data is first data, the second register includes a first half of bits that correspond to most significant bits of the second register and a second half of bits that correspond to least significant bits of the second register, and the data loading circuitry is to, based on at least one of the first value or the second value corresponding to one move second data from a first portion of the most significant bits to a second portion of the least significant bits of the second register, and store the first data in a third portion of the second register, the third portion including the first portion of the most significant bits of the second register and a fourth portion of the least significant bits of the second register.

Example 14 includes the apparatus of example 11, wherein an indication of a first location of the first value and an indication of a second location of the second value are operands of a move instruction.

Example 15 includes the apparatus of example 14, wherein an indication of the first register and an indication of the second register are operands of the move instruction.

Example 16 includes the apparatus of example 14, wherein the data loading circuitry is to store the data into the second register to execute the move instruction.

Example 17 includes the apparatus of example 11, wherein the first value and the second value correspond to an alignment of the data.

Example 18 includes a non-transitory computer readable storage medium comprising a load instruction to cause programmable circuitry to at least determine least significant bits of an address of memory corresponding to the load instruction, and determine an aligned address by zeroing out the least significant bits from the address, read data from the aligned address, and store the data into a register based on the least significant bits of the address.

Example 19 includes the non-transitory computer readable storage medium of example 18, wherein the load instruction causes the programmable circuitry to determine the aligned address by performing a logical AND operation using the address and a number.

Example 20 includes the non-transitory computer readable storage medium of example 19, wherein the number includes a value of zero for the least two significant bits and a value of one for the remaining of the bits of the number.

Example 21 includes the non-transitory computer readable storage medium of example 18, wherein the data is first data, the register includes a first half of bits that correspond to most significant bits of the register and a second half of bits that correspond to least significant bits of the register, and the load instruction causes the programmable circuitry to, based on the least significant bits of the address corresponding to zeros move second data from the most significant bits of the register to the least significant bits of the register, and store the first data into the most significant bits of the register.

Example 22 includes the non-transitory computer readable storage medium of example 18, wherein the data is first data, the register includes a first half of bits that correspond to most significant bits of the register and a second half of bits that correspond to least significant bits of the register, and the load instruction causes the programmable circuitry to, based on at least one of the least significant bits of the address corresponding to a one move second data from a first portion of the most significant bits of the register to a second portion of the least significant bits of the register, and store the first data in a third portion of the register, the third portion including the first portion of the most significant bits of the register and a fourth portion of the least significant bits of the register.

Example 23 includes the non-transitory computer readable storage medium of example 18, wherein the address of the memory and an indication of the register are operands of the load instruction.

Example 24 includes the non-transitory computer readable storage medium of example 23, wherein the memory stores the data at the address.

Example 25 includes the non-transitory computer readable storage medium of example 18, wherein the least significant bits of the address of the memory correspond to an alignment of the data.

Example 26 includes a non-transitory computer readable storage medium comprising a move instruction to cause programmable circuitry to at least determine a first value and a second value stored in a status register, read data from a first register, and store the data into a second register based on the first value and the second value.

Example 27 includes the non-transitory computer readable storage medium of example 26, wherein the move instruction causes the programmable circuitry to, based on the first value and the second value being zero, store the data into the least significant bits of the second register.

Example 28 includes the non-transitory computer readable storage medium of example 26, wherein the data is first data, the second register includes a first half of bits that correspond to most significant bits of the second register and a second half of bits that correspond to least significant bits of the second register, and the move instruction causes the programmable circuitry to, based on at least one of the first value or the second value corresponding to one move second data from a first portion of the most significant bits to a second portion of the least significant bits of the second register, and store the first data in a third portion of the second register, the third portion including the first portion of the most significant bits of the second register and a fourth portion of the least significant bits of the second register.

Example 29 includes the non-transitory computer readable storage medium of example 26, wherein an indication of a first location of the first value and an indication of a second location of the second value are operands of the move instruction.

Example 30 includes the non-transitory computer readable storage medium of example 27, wherein an indication of the first register and an indication of the second register are operands of the move instruction.

Example 31 includes the non-transitory computer readable storage medium of example 26, wherein the first value and the second value correspond to an alignment of the data.

Modifications are possible in the described embodiments, and other embodiments are possible, within the scope of the claims.

The invention claimed is:

1. An apparatus comprising:
a register including a first portion and a second portion;
an interface; and
a decoder coupled to the register and to the interface and configured to, responsive to obtaining an instruction:
cause a first set of data to be moved from the first portion of the register to the second portion of the register based on an address identified in the instruction;
cause the interface to read a second set of data from an aligned address of a memory; and
cause the second set of data to be stored into the register at a location based on the address identified in the instruction.

2. The apparatus of claim 1, wherein the decoder is to:
determine least significant bits of the address of the memory corresponding to a load instruction; and
determine the aligned address by zeroing out the least significant bits from the address, the aligned address defining the first portion of the register and the second portion of the register.

3. The apparatus of claim 2, wherein the decoder is to determine the aligned address by performing a logical AND operation using the address and a number.

4. The apparatus of claim 3, wherein the number includes a value of zero for the least two significant bits and a value of one for the remaining bits of the number.

5. The apparatus of claim 2, wherein the register includes a first half of bits that correspond to most significant bits of the register and a second half of bits that correspond to least significant bits of the register, and the decoder is configured to, when the least significant bits of the address correspond to zeros:
cause the first set of data to be moved from the most significant bits of the register to the least significant bits of the register; and
cause the second set of data to be stored into the most significant bits of the register.

6. The apparatus of claim 2, wherein the register includes a first half of bits that correspond to most significant bits of the register and a second half of bits that correspond to least significant bits of the register, and the decoder is configured to, when at least one of the least significant bits of the address corresponds to a one:
cause the first set of data to be moved from a third portion of the most significant bits of the register to a fourth portion of the least significant bits of the register; and
cause the second set of data to be stored in a fifth portion of the register, the fifth portion including the third portion of the most significant bits of the register and a sixth portion of the least significant bits of the register.

7. The apparatus of claim 1, wherein the address of the memory and an indication of the register are operands of the instruction.

8. The apparatus of claim 5, wherein the memory stores the data at the address.

9. The apparatus of claim 5, wherein the decoder is to store the data into the register to execute the instruction.

10. The apparatus of claim 2, wherein the least significant bits of the address of the memory correspond to an alignment of the data.

11. An apparatus comprising:
logic circuitry configured to determine a first value and a second value stored in a status register;
an interface configured to read data from a first register; and
data loading circuitry configured to store the data into a second register based on the first value and the second value.

12. The apparatus of claim 11, wherein the data loading circuitry is to, when the first value and the second value are zero, store the data into the least significant bits of the second register.

13. The apparatus of claim 11, wherein the data is first data, the second register includes a first half of bits that correspond to most significant bits of the second register and a second half of bits that correspond to least significant bits of the second register, and the data loading circuitry is to, based on at least one of the first value or the second value corresponding to one:
move second data from a first portion of the most significant bits to a second portion of the least significant bits of the second register; and
store the first data in a third portion of the second register, the third portion including the first portion of the most significant bits of the second register and a fourth portion of the least significant bits of the second register.

14. The apparatus of claim 11, wherein an indication of a first location of the first value and an indication of a second location of the second value are operands of a move instruction.

15. The apparatus of claim 14, wherein an indication of the first register and an indication of the second register are operands of the move instruction.

16. The apparatus of claim 14, wherein the data loading circuitry is to store the data into the second register to execute the move instruction.

17. The apparatus of claim 11, wherein the first value and the second value correspond to an alignment of the data.

18. A non-transitory computer readable storage medium comprising a load instruction to cause programmable circuitry to at least:
determine least significant bits of an address of memory corresponding to the load instruction; and
determine an aligned address by zeroing out the least significant bits from the address;
read data from the aligned address; and
store the data into a register based on the least significant bits of the address.

19. The non-transitory computer readable storage medium of claim 18, wherein the load instruction causes the programmable circuitry to determine the aligned address by performing a logical AND operation using the address and a number.

20. The non-transitory computer readable storage medium of claim 19, wherein the number includes a value of zero for the least two significant bits and a value of one for the remaining of the bits of the number.

21. (canceled)

22. (canceled)

23. (canceled)

24. (canceled)

25. (canceled)

26. (canceled)

27. (canceled)

28. (canceled)

29. (canceled)

30. (canceled)

31. (canceled)
